(19) United States
(12) Patent Application Publication
(10) Pub. No.: US 2006/0169544 A1
(43) Pub. Date: Aug. 3, 2006

(54) Drive for an elevator installation

(75) Inventor: Daniel Fischer, Ollon/VD (CH)

Correspondence Address: BUTZEL LONG;DOCKETING DEPARTMENT, 100 BLOOMFIELD HILLS PARKWAY, SUITE 200, BLOOMFIELD HILLS, MI, 48304, US

(73) Assignee: Inventio AG

(21) Appl. No.: 11/147,086

(22) Filed: Jun. 7, 2005

(30) Foreign Application Priority Data
Jun. 19, 2004 (EP) 04014438.8

(51) Int. Cl. B66B 5/16

(52) U.S. Cl. 187/351

(57) ABSTRACT

A drive for an elevator installation which drives a car and a counterweight by way of supporting and driving belts includes a drive shaft and a drive pulley. A motor is arranged adjacent either side of the drive pulley and a brake is fastened to the drive by pins.

### BACKGROUND OF THE INVENTION

The present invention relates to a drive for an elevator installation.

An elevator installation consists of a car for reception of goods or persons to be transported and a counterweight, or a second car, which are connected together by way of supporting and driving means via a drive. The drive of the elevator installation in that case has the object of driving the driving and supporting means and thus an alternate raising and lowering of the car and the counterweight.

The drive consists of the principal components of a drive pulley, a motor and a brake. The drive pulley receives the supporting and driving means and transmits drive forces to the supporting and driving means by way of a mechanically positive or friction couple. The motor for its part drives the drive pulley, and the brake brakes the drive pulley. Motor, brake and drive pulley are accordingly connected together in terms of force and torque.

A drive for an elevator is shown in the European patent document EP 1 400 477 in which a motor drives drive pulleys by means of a drive shaft and the drive pulleys are braked by a brake. The drive pulleys are in that case, in a preferred form of embodiment, arranged between the motor and the brake unit. The drive pulleys drive flat belts. This allows use of small drive pulley diameters. The drive can thereby be of small and compact construction.

However, the small dimensions and compact mode of construction of this drive create new challenges. The brake housing and the motor housing have to be connected together in terms of force and torque. The connection with the brake has to conform to safety standards, i.e. has to be constructed with at least a mechanically positive couple. In that case the small dimensions shall be maintained.

### SUMMARY OF THE INVENTION

An object of the present invention is to provide a drive for an elevator installation which has small external dimensions, is constructed in conformity with safety and can be produced economically.

The present invention relates to a drive for an elevator installation which drives a car and a counterweight by way of supporting and driving means and the drive comprises a drive pulley, which is driven by a motor by way of a drive shaft and is braked by a brake, wherein the drive shaft, the motor and the brake together with a support are combined into a unit. The support forms the common supporting structure of the drive at which, depending on the respective mode of construction, parts of the drive are arranged. It enables fastening of the drive in the building. The support can in that case be an integral component of the motor or the brake or it can be a housing which, for example, receives bearing points of the drive or encloses the drive pulleys.

According to the present invention the brake is connected by means of pins with the housing of the motor or with the support or with a further brake. This means that the torque transmission from the brake to the support or to the housing of the motor or to a next brake takes place by means of the pins. Advantageously in that case the housing of the motor or the support, and the brake or a stationary part of the brake, contains a pin bore. The pin is inserted in the pin bore of the motor or of the support. The brake is fastened on the corresponding pin by means of the pin bore at the brake side. The brake is thus connected with the motor or the support fixedly in terms of torque or in a mechanically positive manner. The pins as well as the connecting points at the brake and the housing or the support can be produced in simple manner. An economic and space-saving connection of the brake in the drive is thereby possible, which additionally fulfils safety demands imposed on a mechanically positive connection.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross-sectional view of a drive constructed in accordance with the present invention;

FIG. 2 is a cross-sectional view of an alternate embodiment drive constructed in accordance with the present invention; and

FIG. 3 is an enlarged fragmentary view the brake fastening by means of pins shown in FIGS. 1 and 2.

### DESCRIPTION OF THE PREFERRED EMBODIMENT

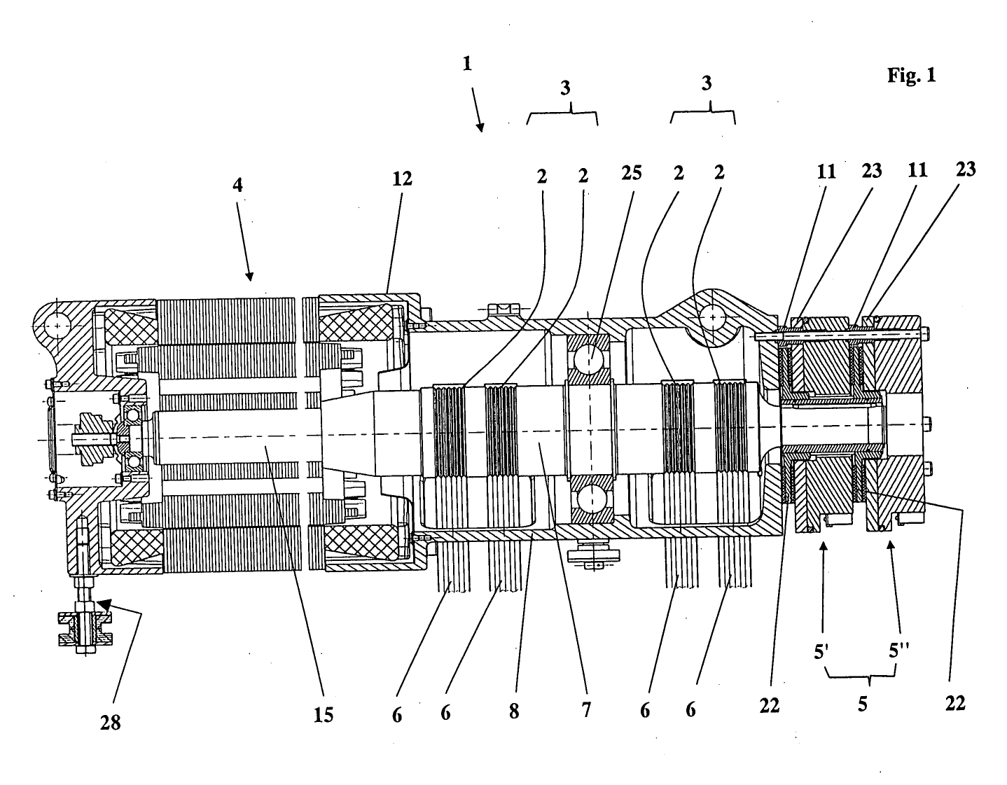

FIG. 1 shows a drive 1 for an elevator installation with the main characteristics of the present invention. The drive 1 has one or more drive pulley zones 3 that each has at least one drive pulley 2. The drive pulley 2 serves for reception of a supporting and driving means 6 which connects a car of the elevator installation with a counterweight or a second car. The drive pulley 2 is, in the case of the illustrated drive 1, integrated in a drive shaft 7. A motor 4 driving the drive shaft 7 is arranged in an adjoining manner at the drive pulley 2.

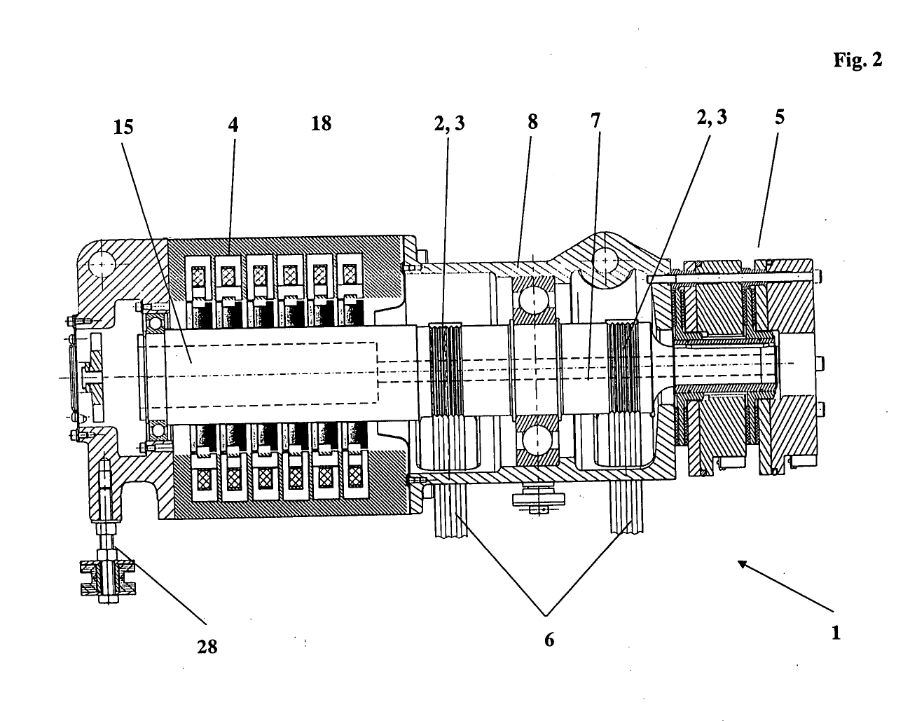

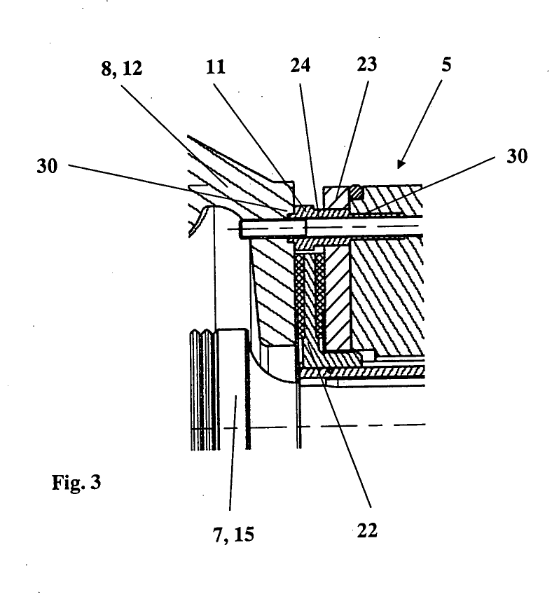

According to the present invention a brake 5 or a stationary part of the brake, as illustrated in FIGS. 1, 2 and 3, is connected with a support 8 by means of bolts, pegs or pins 11. The fastening of the brake 5 is in that case carried out, with consideration of space conditions and an optimum force flow, selectably to a housing 12 of the motor 4, as illustrated in FIG. 3, or to the support 8 as illustrated in FIGS. 1 and 2. The use of the pins 11 forms an economic and space-saving construction for fastening of the brake 5.

Advantageously the pin 11 is plugged at one end thereof into a matching pin bore 30 of the support 8 or the housing 12, or the end of the pin 11 is recessed into the support 8 or the housing 12. The housing of the brake 5, or a stationary part of the brake 5, is placed on an opposite end of the pin 11. The pin 11 defines a predetermined spacing between the brake 5 and the support 8 or the housing 12. A brake disc 22 and a brake pressure plate 23 are arranged within the predetermined spacing. The brake disc 22 is connected in force-locking manner with a motor shaft 15 or the drive shaft 7 and rotates at the rotational speed of the motor 4. The brake pressure plate 23 is, in the operational setting of the drive 1, drawn towards the housing of the brake 5, for example by means of an electromagnet, and in the braking setting is switched free or pressed against the brake disc 22. The pressing is usually carried out by means of springs. The brake disc 22 is thereby firmly clamped between the brake pressure plate 23 and a counter-housing, such as, for example, the support 8, the housing 12 of the motor or a further brake 5′, and thereby brakes the motor shaft 15 or the drive shaft 7. The brake pressure plate 23 is guided by means of the pin 11, whereby it is secured against turning. The pins 11 and the pin bores 30 can be produced economically. The drive 1 can thereby be produced economically. The illustrated embodiment in addition demands little space.

As a rule several of the pins 11 are mounted to be distributed over the circumference of the brake 5. The brake 5 is fastened by means of screws, which are preferably led through a longitudinal bore 24 of the pin 11.

The pins 11 as well as the connecting points at the brake 5 and the housing 12 of the motor 4, or the support 8, considered overall can be simply produced. An economic and space-saving attachment of the brake 5 in the drive 1 is thereby possible, which in addition fulfils safety requirements imposed on a mechanically positive attachment of the brake to the motor.

In a particularly secure construction two brake modules 5′, 5″ are connected together into the one brake 5 as illustrated in FIG. 1 and FIG. 2. A twin-circuit brake can thereby be constructed, which can also be used for safety-relevant functions.

As illustrated in FIGS. 1 and 2, the drive 1 in a preferred embodiment consists of the two mutually spaced-apart drive zones 3, wherein the drive zone 3 can contain one or more of the drive pulleys 2. The motor 4 and/or the brake 5 is or are arranged outside the two drive zones 3 and a main bearing 25 is arranged between the two drive zones 3, so that a main supporting force of the carrying force, which is produced by the supporting and driving belts 6, is substantially introduced into a supporting structure by means of the main bearing 25.

A direct and optimum introduction of the supporting forces of the drive 1 into a supporting structure is thus made possible. The drive can thereby be of compact construction and realized economically.

The use of belts as the supporting and driving means 6 is particularly advantageous. The supporting and driving belts 6 allow use of small drive pulley diameters. The drive 1 with correspondingly high rotational speeds and low torques can thereby be used, which in turn permits use of drives with small dimensions and correspondingly economic brakes.

The flat belts in that case are, in correspondence with the construction of the traction surface of the drive pulley 2, flat, i.e. smooth, or they have a longitudinal profiling, for example in the form of wedge ribs, or they have a transverse profile, for example a tooth shape.

In the illustrated examples of FIG. 1 and FIG. 2, the motor shaft 15, the drive shaft 7 and the drive pulley 2 are of integral construction. Alternatively, merely the motor shaft 15 and the drive shaft 7 can be of integral construction, or the drive shaft 7 and the drive pulley 2 are made from one piece. Production as individual separate parts is obviously also possible. Selection of the suitable form of embodiment is carried out according to the choice of the manufacturer.

The introduction of a supporting force by means of a support 28 mounted at the motor side relieves the brake 5, in the illustrated example, of supporting forces. The pin 11, or the brake attachment, is thereby loaded only by the forces intrinsic to the brake 5, i.e. braking moment and pressing force.

The illustrated forms of embodiment and methods are examples. Thus, for example, the brake 5 can also be arranged at the end of the drive shaft 7 at the motor side, for example outside the support 28.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A drive for an elevator installation that drives a car and a counterweight with a supporting and driving means comprising:
a drive shaft;
a drive pulley coupled to said drive shaft for engaging the supporting and driving means;
a motor coupled to said drive shaft for rotating said drive pulley;
a brake coupled to said drive shaft and positioned at one of adjacent said drive pulley and at an end of said motor; and
at least one pin attaching said brake to one of a support of the drive and a housing of said motor.

2. The drive according to claim 1 wherein said brake includes at least two brake modules attached together.

3. The drive according to claim 1 wherein said at least one pin spaces a housing of said brake from said one of said support and said housing of said motor.

4. The drive according to claim 1 wherein an end of said at least one pin is recessed in said brake and another end of said at least one pin is recessed in said one of said support and said housing of said motor.

5. The drive according to claim 1 wherein said at least one pin has a longitudinal bore and including a fastener extending through said bore to attach said brake to said one of said support and said housing of said motor.

6. The drive according to claim 1 wherein said brake includes at least two brake modules attached together by said at least one pin.

7. The drive according to claim 6 wherein said at least one pin spaces a housing of one of said brake modules from a housing of another of said brake modules.

8. The drive according to claim 6 wherein an end of said at least one pin is recessed in one of said brake modules and another end of said at least one pin is recessed in another one of said brake modules.

9. The drive according to claim 6 wherein said at least one pin has a longitudinal bore and including a fastener extending through said bore to attach said at least two brake modules together.

10. The drive according to claim 1 wherein the drive includes at least two mutually spaced-apart drive zones each with at least one of said drive pulley, a main bearing is arranged between the at least two drive zones and at least one of said motor and said brake is arranged outside the drive zones.

11. The drive according to claim 1 wherein the supporting and driving means is a belt and a traction surface of said drive pulley is one of flat, longitudinally profiled or transversely profiled.

12. The drive according to claim 1 wherein said motor has a motor shaft integral with said drive shaft.

13. The drive according to claim 12 wherein said drive shaft and said drive pulley are of integral construction.

14. The drive according to claim 1 wherein said drive shaft and said drive pulley are of integral construction.

15. A drive for an elevator installation that drives a car and a counterweight with a supporting and driving means comprising:
a support;
a drive shaft rotatably mounted on said support;
at least one drive pulley coupled to said drive shaft for engaging the supporting and driving means;
a motor coupled to an end of said drive shaft for rotating said at least one drive pulley;
a brake coupled to another end of said drive shaft for braking said at least one drive pulley and said motor; and
at least two pins attaching said brake to said support.

16. The drive according to claim 15 wherein each of said pins has a longitudinal bore and including an associated fastener extending through said bore to attach said brake to said support.

17. The drive according to claim 15 wherein said brake includes at least two brake modules attached together by said at least two pins.
